(19) United States
(12) Patent Application Publication
(10) Pub. No.: US 2011/0109506 A1
(43) Pub. Date: May 12, 2011

(54) Simulating Phase-Coherent GNSS Signals

(75) Inventors: Todd E. Humphreys, Austin, TX (US); Brent M. Ledvina, San Francisco, CA (US); William J. Bencze, Half Moon Bay, CA (US); Bryan T. Galusha, San Francisco, CA (US); Clark E. Cohen, Washington, DC (US)

(73) Assignee: COHERENT NAVIGATION, INC., San Mateo, CA (US)

(21) Appl. No.: 12/889,247

(22) Filed: Sep. 23, 2010

Related U.S. Application Data
(60) Provisional application No. 61/245,658, filed on Sep. 24, 2009.
(60) Provisional application No. 61/245,652, filed on Sep. 24, 2009.
(60) Provisional application No. 61/245,655, filed on Sep. 24, 2009.

(51) Int. Cl. G01S 19/29

(52) U.S. Cl. 342/357.68

(57) ABSTRACT

A method and apparatus for simulating radio-frequency Global Navigation Satellite System (GNSS) signals that are carrier-phase and code-phase aligned with ambient GNSS signals at a user-specified location in the vicinity of the simulator. Such phase alignment allows the synthesized signals to be made to appear substantially the same as the authentic signals to a target receiver, allowing the target receiver to transition seamlessly between authentic and simulated signals. The method is embodied in a device, a phase-coherent GNSS signal simulator, which can be implemented on a digital signal processor for embedded applications.

### CROSS-REFERENCE TO RELATED APPLICATIONS

This application claims priority to provisional application Nos. 61/245,658, filed Sep. 24, 2009, titled “AUGMENTING GNSS USER EQUIPMENT TO IMPROVE RESISTANCE TO SPOOFING”; 61/245,652, filed Sep. 24, 2009, titled “Simulating Phase-Aligned GNSS Signals; and 61/245,655, filed Sep. 24, 2009, titled “Assimilating GNSS Signals to Improve Accuracy, Robustness, and Resistance to Spoofing”, which are incorporated herein in their entirety by reference.

### TECHNICAL FIELD

This invention relates generally to GNSS navigation, and more particularly to GNSS signal simulators.

### BACKGROUND

Global Navigation Satellite System (GNSS) signal simulators generate signals whose structure, strength, ranging-code phase, and carrier Doppler shift frequency are representative of actual GNSS signals transmitted by Earth-orbiting GNSS constellations. Such simulators are generally used to test GNSS user equipment. GNSS simulators are primarily used to explore fictitious scenarios independent of any ambient authentic GNSS signals in the vicinity of the simulator at the time. Accordingly, known GNSS simulators do not generate GNSS signals that are coherently aligned in ranging-code phase or carrier phase with an authentic GNSS broadcast signal.

A particular GNSS simulator called a pseudolite, or pseudo-satellite, broadcasts a GNSS-like signal consistent with a fictitious GNSS satellite transmitting from the pseudolite's location. The pseudolite's pseudo-random code is selected to be different from those of visible GNSS satellites and from those of other pseudolites.

A GNSS synchrolite, or synchronized pseudo-satellite, is a pseudolite that rebroadcasts a replica of one or more incoming GNSS signals from a known, fixed location. Nearby GNSS users can compute a precise differential position by combining direct GNSS signals with those rebroadcast by the synchrolite.

Pseudolites augment and synchrolites rebroadcast ambient GNSS signals, but neither generally serves as a GNSS constellation simulator, i.e., they do not generate signals that are sufficient alone to define or to be consistent with a user-specified location and time.

Accordingly, improvements are sought in the simulation of ambient GNSS signals.

### SUMMARY

In some implementations, a phase-coherent GNSS signal simulator provides multiple modes of operation. In a first mode, the simulator generates multiple GNSS signals whose defined navigation and timing solution is consistent with an arbitrary position, velocity, and time selected by the user. In a second mode, a phase-coherent mode, the simulator generates multiple GNSS signals that, if broadcast from the location of the simulator's radio frequency output, would have carrier and code phases that are aligned with the carrier and code phases of the corresponding authentic GNSS signals at an arbitrary nearby location (e.g., within approximately 10 km) specified by the user.

In the phase-coherent mode, the simulator aligns the simulated GNSS signals to the authentic GNSS signals to within a fraction of a carrier wavelength (e.g., a few centimeters or better). To achieve this precision, the simulator functionality is tightly coupled to a GNSS receiver. In some implementations, the phase-coherent signal simulator includes a coupled receiver-simulator pair. The coupled receiver and the simulator share a common reference oscillator or other suitable timing reference, which permits the simulator to precisely reference the code and carrier phase alignment of the simulated signals to that of the authentic signals being tracked by the coupled receiver. In some embedded applications, the receiver and simulator components of the phase-coherent signal simulator can both be implemented on the same digital signal processor.

In some implementations, one aspect of the invention features a GNSS phase-coherent signal simulator including a GNSS signal receiver configured to receive one or more ambient radio-frequency GNSS signals. A GNSS signal simulator is configured to generate one or more simulated radio-frequency GNSS signals. An oscillator is configured as a timing reference for both the GNSS signal receiver and the GNSS signal simulator. A control module is configured to align both a carrier phase and a code phase of the one or more simulated GNSS signals respectively with a carrier phase and a code phase of the one or more ambient radio-frequency GNSS signals at a predetermined three-dimensional position offset and a predetermined velocity offset relative to a reference location on the GNSS phase-coherent signal simulator.

In some cases, the position offset is substantially zero, e.g., when the selected position substantially coincides with the location of the user. In some cases, the velocity offset is substantially zero. In some cases, the position offset is less than about 10 km.

In some cases, the output is code and carrier phase coherently aligned with the ambient broadcast GNSS signals at the receiver. In some cases, the code and carrier phase may be coherently aligned remote from or even travelling with respect to the GNSS Assimilator, for example, to generate a spoofing signal, or more likely, a counter spoofing signal from a distance.

In some implementations, the position offset and velocity offset are individually selectively variable.

In some implementations, the signal simulator is configured to compensate for a signal processing latency.

In some cases, the signal simulator is configured to align the simulated GNSS signal with the ambient GNSS signal within one tenth of a carrier wavelength.

In some cases, the receiver is further configured to estimate a Doppler frequency offset. In some implementations, the signal simulator is further configured to set the Doppler frequency offset to within about 1 Hz.

In some applications, another aspect of the invention features a method of combining a plurality of GNSS signals including, receiving, at a GNSS signal receiver, one or more ambient radio-frequency GNSS signals. The method further includes generating, with a GNSS signal simulator, one or more simulated radio-frequency GNSS signals and receiving, at both the GNSS signal receiver and the GNSS signal simulator, a common timing reference. The method further includes aligning, via a control module, both a carrier phase and a code phase of the one or more simulated radio-frequency GNSS signals respectively with a carrier phase and a code phase of the one or more ambient radio-frequency GNSS signals at a predetermined three-dimensional position offset and a predetermined velocity offset relative to a reference location on the GNSS signal simulator.

In some applications, the aligning includes compensation for signal processing latency.

In some applications, the method includes calibrating the GNSS signal simulator to account for signal processing latency.

In some applications, the method includes calibrating the GNSS signal simulator to account for RF reception and transmission biases in filters, mixers, and RF cabling.

In some applications, the velocity offset is selected for carrier phase and code phase alignment at a stationary point.

In some applications, the velocity offset is selected for continuous carrier phase and code phase alignment along a trajectory of a moving point.

In some applications, the simulated GNSS signal is aligned with the ambient GNSS signal within a few centimeters of a carrier wavelength.

In some cases, the method includes estimating a Doppler frequency offset. In some cases, the Doppler frequency offset is set to within about 1 Hz.

In some cases, the phases are aligned within approximately one degree.

In some applications, another aspect of the invention features a method of phase aligning GNSS signals via a GNSS signal simulator. The method includes receiving one or more ambient radio-frequency GNSS signals and generating one or more simulated radio-frequency GNSS signals. The method further includes aligning both a carrier phase and a code phase of the one or more simulated radio-frequency GNSS signals respectively with a carrier phase and a code phase of the one or more ambient radio-frequency GNSS signals at a predetermined three-dimensional position offset and a predetermined velocity offset relative to a reference location on the GNSS phase-coherent signal simulator.

In some applications, the method includes providing a timing reference to a GNSS receiver and the GNSS simulator via an oscillator to facilitate phase alignment.

Accordingly, in some applications, it is useful to simulate authentic GNSS signals that are present near the simulator at the time of operation and, further, to phase-align the simulated signals with the authentic signals. In a particular example, the simulator may be used as a platform for studying the effects of GNSS spoofing via phase alignment of simulated and authentic signals.

In some applications, a device designed to aid a GNSS receiver during periods of signal blockage or jamming by synthesizing clean GNSS signals enables a seamless transition from GNSS-available to GNSS-denied environments by phase-aligning the synthesized and ambient signals.

In some applications, the phase-coherent GNSS signal simulator leverages an embedded GNSS receiver (a coupled receiver) to synthesize GNSS signals that are phase-aligned with their authentic counterpart signals at a user-specified location (e.g., at the input to a target receiver). In some cases, the simulator is designed to align the signal output with the corresponding authentic signals to within a fraction of a carrier wavelength.

The phase-coherent GNSS signal simulator differs in capability from a GNSS signal simulator, primarily by providing the ability to accurately synchronize the output GNSS signals to the ambient GNSS signals broadcast by GNSS satellites. The synchronization can be performed to an accuracy of a few centimeters or better of the code and carrier phase of the simulated GNSS signals with respect to the broadcast authentic GNSS signals.

The phase-coherent GNSS signal simulator differs both in capability and function from GNSS pseudolites and synchrolites. By setting the relative position ΔP and relative velocity ΔV inputs to zero, the phase-coherent GNSS signal simulator may align the code and carrier phases with ambient broadcast signals at the receiver. Alternatively, by setting the offsets to non-zero, the phase-coherent GNSS signal simulator can produce GNSS signals that are carrier-phase and code-phase-coherent with corresponding authentic GNSS signals not just at the simulator's location but at any nearby location (the simulator's location plus the user-specified position offset ΔP), or even along a moving trajectory. Furthermore, the phase-coherent GNSS signal simulator is not limited to rebroadcasting incoming GNSS signals, but can, in some implementations, generate false GNSS signals different from those it receives.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a GNSS navigation system employing GNSS and auxiliary non-GNSS signals.

FIG. 2 is a block diagram of a GNSS navigation receiver.

FIG. 3 is a functional block diagram of the phase-coherent GNSS signal simulator.

FIG. 4 is a flow chart of an illustrative process for synthesizing phase-coherent GNSS signals.

Like reference symbols in the various drawings indicate like elements.

### DETAILED DESCRIPTION

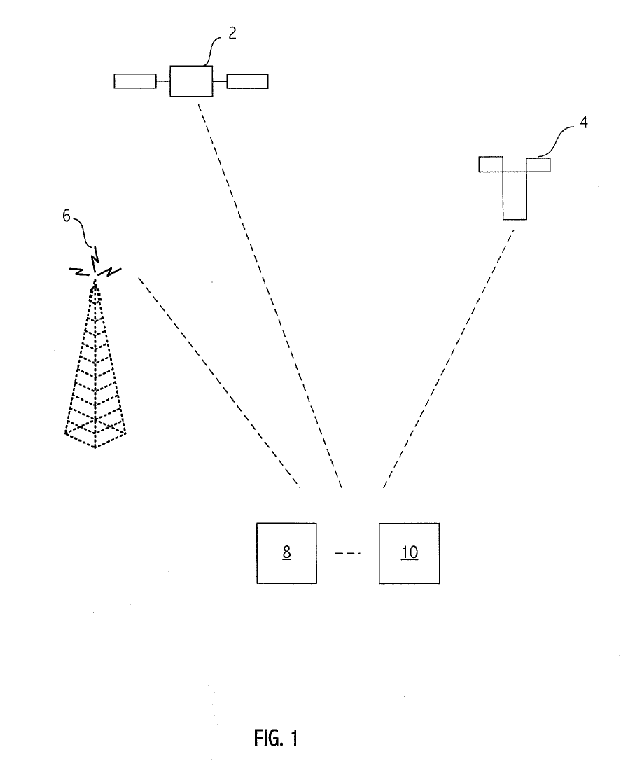

With reference to FIG. 1, a GNSS navigation receiver 10 is capable of providing a positional and/or timing solution based on signals from one or more GNSS satellites 2, non-GNSS satellites 4, and/or terrestrial RF sources 6. A phase-coherent GNSS signal simulator 8 is configured to provide GNSS signals bearing navigation-useful signal data to GNSS navigation receiver 10. In one mode, the phase-coherent GNSS signal simulator 8 can selectively provide data defining a navigation solution corresponding to a selected position, velocity and time. In another mode, the phase-coherent GNSS signal simulator 8 generates GNSS signals having carrier and code phases aligned with the carrier and code phases of an authentic GNSS signal at a selected location.

For example, in some applications, the non-GNSS satellite 4 is a LEO satellite, e.g., Iridium™ satellite, providing data useful to phase-coherent GNSS signal simulator 8 in providing timing, positional or navigational solution useful data to GNSS navigation receiver 10.

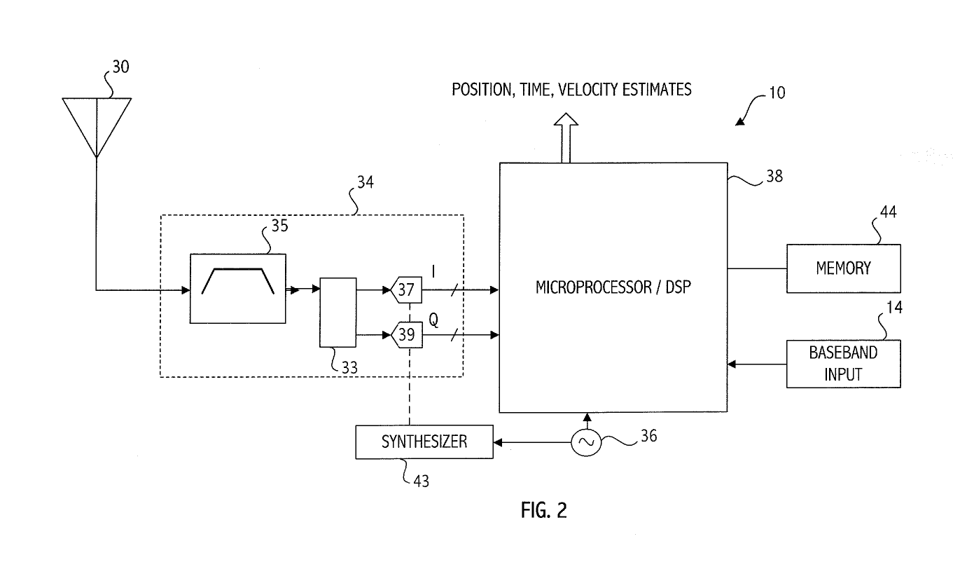

With reference to FIG. 2, basic architecture of a GNSS navigation receiver 10 can include a multi-system antenna 30 to receive the satellite signals and other RF signals, front end 34 including a bandpass filter 35, preamp and a clock 36, e.g., reference crystal oscillator. The RF front-end 34 draws in signals from the multi-system antenna 30 and filters, mixes, and digitizes the signals. The output of the RF front-end 34 is a stream of digital data samples that are routed to the digital signal processor (DSP) 38. Structurally, the DSP 38 processes computer programming instructions stored in memory 44, e.g., to determine navigation radio position. DSP 38 may also receive baseband input such as inertial measurements, a time synchronization pulse, or PVT input from a user.

A synthesizer 43 provides a coherent sine wave and clock signals to be used by other radio components based on a clock signal received by the synthesizer. For example, an inertial sensor provides accelerometer and rate-gyro baseband inputs 14 time tag synchronized to receiver clock 36 and may be used to provide raw digital motion samples. GNSS navigation receiver 10 calculates an estimate of the bias of radio clock 36 to compensate for measured errors in a satellite clock, reference station clock, multiple receiver clocks and/or time slot changes in a transmission sequence and the like. Some implementations include RF front-end 34 that downconvert to an intermediate frequency (IF), however, a direct downconversion to baseband may be used.

The front-end 34 of the receiver 10 downconverts the received RF signal into an intermediate frequency signal, which is output to the DSP 38. The front-end 34 can carry out various bandpass, automatic gain control (AGC), direct RF sampling and A/D conversion functions and may use direct or traditional inphase and quadrature downconversion schemes. For example, a hybrid coupler 33 can separate the signal into in-phase and quadrature components and A/D converters 37, 39 can sample incoming in-phase and quadrature signals and output to DSP 38 digital data useful to derive a range observable. For example, DSP 38 can derive at least one of a pseudorange, carrier phase or Doppler shift range observable for a corresponding satellite. DSP 38 can determine a clock offset between clock 36 and a satellite reference clock. DSP 38 may perform any number of routines with received signals or data including extracting ephemeris information for a corresponding satellite.

Memory 44 stores data and computer programming instructions for processing. Memory 44 may be an EEPROM chip, electromagnetic device, optical storage device, or any other suitable form or type of storage medium. Memory 44 can store, inter alia, ephemerides for the corresponding satellite, local terrain data, and any type of data derived from the received RF signals, inertial sensor or other sensor outputs, user inputs, or other suitable data source. For example, in some cases, satellite ephemerides are transmitted or obtained through other than a satellite signal, e.g., via a ground reference station or over a wireless network connection.

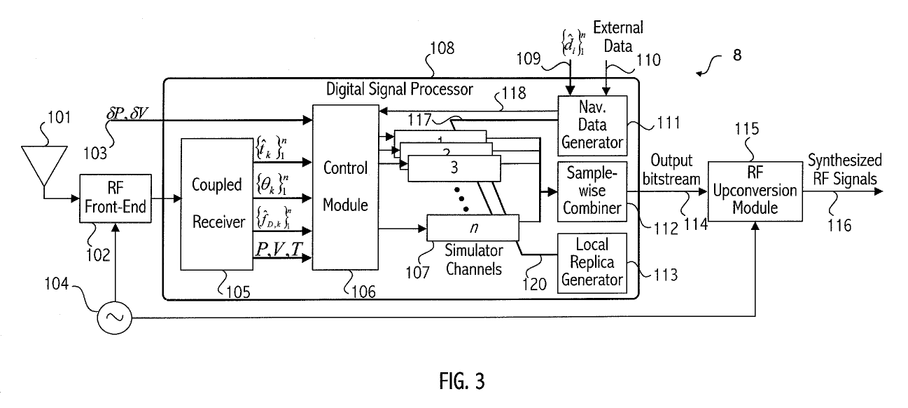

With reference to FIG. 3, various components of one implementation of phase-coherent GNSS signal simulator 8 are described.

The phase-coherent GNSS signal simulator's digital processing functions are implemented on a digital signal processor 108. Alternatively, FPGA or ASIC implementations may be suitably used. Each of the constituent functional blocks of the phase-coherent GNSS signal simulator will be described in turn.

### RF FRONT-END

The radio frequency (RF) front-end 102 draws in GNSS signals from the GNSS antenna 101 and filters, mixes, and digitizes the GNSS signals. The output of the RF front-end is a stream of digital data samples that are routed to the coupled receiver 105. The RF front-end 102 and the RF upconversion module 115 are tied to a common reference oscillator 104.

### COUPLED RECEIVER

The coupled receiver is a digital GNSS receiver such as a GPS receiver configured to correlate local carrier and code replicas with incoming digital data samples to produce complex baseband signal components. These signal components are fed into tracking loops producing outputs from which a navigation and timing solution is derived. Various outputs of the coupled receiver are fed to the control module 106 and the navigation data generator 111, as described below.

### CONTROL MODULE

The control module 106 coordinates the generation of the synthesized GNSS signals 116 by directing the carrier phase, carrier frequency, and code phase in each of n simulator channels 107. The control module 106 accepts the inputs from the coupled receiver including: the estimates {\hat{t}ₖ}₁ⁿ of the start times of the kth ranging code interval on receiver channels 1−n; the estimates {\hat{θ}ₖ}₁ⁿ of the beat carrier phase on receiver channels 1−n at times {\hat{t}ₖ}₁ⁿ; the estimates {\hat{f}_{D,k}}₁ⁿ of the Doppler frequency shift on receiver channels 1−n at times {\hat{t}ₖ}₁ⁿ; the estimated current time T; and the estimated position P and velocity V of the coupled receiver's antenna. The control module also accepts external user input to provide the relative position δP and velocity δV 103 of the specified nearby phase-alignment point with respect to the coupled receiver's antenna.

Operation of the control module 106 in orchestrating signal generation is now described. Given the inputs P, T, δP and given GNSS satellite ephemeris data 118 from the navigation data generator 111, the control module 106 selects a set of GNSS signals to be generated. It configures each of the simulator channels 107 to generate one or more signal within this set. Each signal is generated with a carrier frequency and code phase that is consistent with the position P+δP, velocity V+δV and time T.

If a particular signal chosen for simulation is also being tracked by the coupled receiver, then the control module 106 can direct synthesis of that signal to be effected in phase-coherent mode. That is, the code and carrier phase of the simulator channel 107 are adjusted so that, if transmitted from the simulator's output port, the synthesized signal 116 would be code- and carrier-phase-aligned with the authentic signal at the specified phase-alignment point P+δP. To effect this phase alignment, the control module 106 refers to the inputs \hat{t}ₖ, \hat{θ}ₖ, and \hat{f}_{D,k} corresponding to the simulated signal and calculates carrier- and code-phase offsets to these values that are consistent with the relative position δP and velocity δV.

### SIMULATOR CHANNELS

Each of the n simulator channels 107 can be configured to generate a unique GNSS signal, modeled as

$${x}_{n} ( {τ}_{i} ) = {A}_{n} ( {τ}_{i} ) {d}_{n} ( {τ}_{i} ) {C}_{n} ( {τ}_{i} - {t}_{n , k} ) \times Q \{ sin [ 2 π {f}_{IF} {τ}_{i} + {θ}_{n} ( {τ}_{i} ) ] \}$$

$${θ}_{n} ( {τ}_{i} ) = \{ \begin{matrix}{θ}_{n} ( {τ}_{0} ) = {θ}_{n , 0} \\ 2 π {f}_{D , n , k} \times ( {τ}_{i} - {τ}_{0} ) + {θ}_{n , 0}\end{matrix}$$

where xₙ(τᵢ) is the ith sample of the signal, τᵢ is the time of the ith sample, Aₙ(τᵢ) is the amplitude at τᵢ, dₙ(τᵢ) is the navigation data bit value that applies at τᵢ, Cₙ(τᵢ−t_{n,k}) is the ranging code chip value that applies at τᵢ, t_{n,k} is the start time of the kth ranging code interval, Q{·} is a quantization function, f_{IF}, is the intermediate frequency, θₙ(τᵢ) is the beat carrier phase at τᵢ, and f_{D,n,k} is the Doppler frequency shift at time t_{n,k}. The ranging code function Cₙ(τ) can be expressed as

$${C}_{n} ( τ ) = {\sum }_{j = - ∞}^{∞} {c}_{n , j} {Π}_{{T}_{c}} ( τ - j {T}_{c} )$$

and the navigation data bit function dₙ(τ) as

$${d}_{n} ( τ ) = {\sum }_{j = - ∞}^{∞} {d}_{n , j} {Π}_{{T}_{d}} ( τ - j {T}_{d} )$$

where {c_{n,j}, c_{n,j+1}, . . . } and {d_{n,j}, d_{n,j+1}, . . . } are the unique ranging code chip sequence and navigation data bit sequence corresponding to the GNSS satellite whose signal is being emulated on the nth simulator channel, T_{c} and T_{d} are the duration of one ranging code chip and one navigation data bit, and Π_{T}(τ) is the usual rectangular support function equal to unity over 0≦τ<T and zero otherwise.

### LOCAL REPLICA GENERATOR

The local replica generator 113 generates the ranging code samples {Cₙ(τᵢ)}, i=1, 2, . . . , and the quantized carrier replica samples

Q{sin [2πf_{IF}τᵢ+θₙ(τᵢ)]}, i=1, 2, 3, . . .

A command and data bus 120 conveys phase and frequency information from the simulator channels 107 to the local replica generator 113, and returns local carrier and code replicas from the local replica generator 113 to the simulator channels 107. The local replica generator 113 implementation can include software or hardware components, e.g., FPGA or ASIC. In some implementations, software code modules may be shared between the simulator channels and the coupled receiver.

To generate ranging code samples, the simulator channels can use the same bit-packed C/A code replicas, stored in large look-up tables that are used for signal correlation in the coupled receiver. However, to minimize on-chip memory requirements, in some implementations, the simulator channels need not exploit the same bit-packed carrier replicas used by the coupled receiver. Instead, the simulator channels can utilize a carrier replica generated by the local replica generator. In some implementations, linear feedback shift registers may be used instead of a look-up table to generate the code replicas.

To accurately align the simulated and authentic signals, the local replica generator sets the initial phase of a carrier replica segment to within approximately one degree and the Doppler frequency offset over the segment to within approximately 1 Hz.

### NAVIGATION DATA GENERATOR

The navigation data bit sequence {d_{n,j}, d_{n,j+1}, . . . } required by the nth simulator channel 107 is generated in one of two ways. When a simulator channel 107 is operating in phase-coherent mode, a steady stream of navigation data bits 109 is available from the coupled receiver, which is tracking the corresponding authentic signal. Data bits extracted from the authentic signal are fed to the navigation data generator 111 and compiled into a signal-specific databit library, from which, in turn, the satellite-specific ephemeris data 118 used by the control module 106 are extracted. Once the desired components of this library are complete, data bits for the simulator channel are drawn sequentially from the library through the navigation data generator data bus 117. Data bits in the navigation data sequence that are not required for the target receiver to compute a PVT estimate from the simulated GNSS signals may be populated with dummy values.

If the coupled receiver loses lock on an authentic signal corresponding to one being simulated, then the corresponding simulator channel 107 transitions from phase-coherent mode to standard mode. In this case, the navigation data generator 111 continues to populate the simulated bitstream with navigation data from the data bit library, but the library no longer is updated as before. This continues until the control module reconfigures the simulator channel to generate another GNSS signal.

If a simulator channel 107 is configured to generate a GNSS signal for which there is no recent databit library, then the navigation data generator 111 produces data bits consistent with a standard ephemeris for the corresponding satellite. The navigation data generator can also accept a user-supplied satellite data 110 in the form of a databit library or a satellite ephemeris.

### SAMPLE-WISE COMBINER

Combination of the signals generated in each of the simulator channels is performed digitally sample-by-sample in the sample-wise combiner 112. The ith sample from the nth simulator channel is weighted by the simulated amplitude Aₙ(τᵢ) and summed with the corresponding samples from the other simulator channels. The sample-wise operations thus generate a linear combination of the individual quantized simulated signals. The combined signal is then re-quantized to produce an output bitstream 114. In some cases, simulated noise can be added to the output bitstream or a signal attenuator may be used to enhance compatibility with a target receiver.

### RF UPCONVERSION MODULE

The output bitstream 114 of the sample-wise combiner 112 is routed to an RF upconversion module 115 comprising a digital-to-analog converter, frequency mixers, filters, and optionally a signal attenuator. The upconversion module converts the digital signal into a set of synthesized GNSS signals at RF 116. The reference oscillator 104 that drives the RF upconversion module is also the reference oscillator for the RF front-end 102 of the coupled receiver.

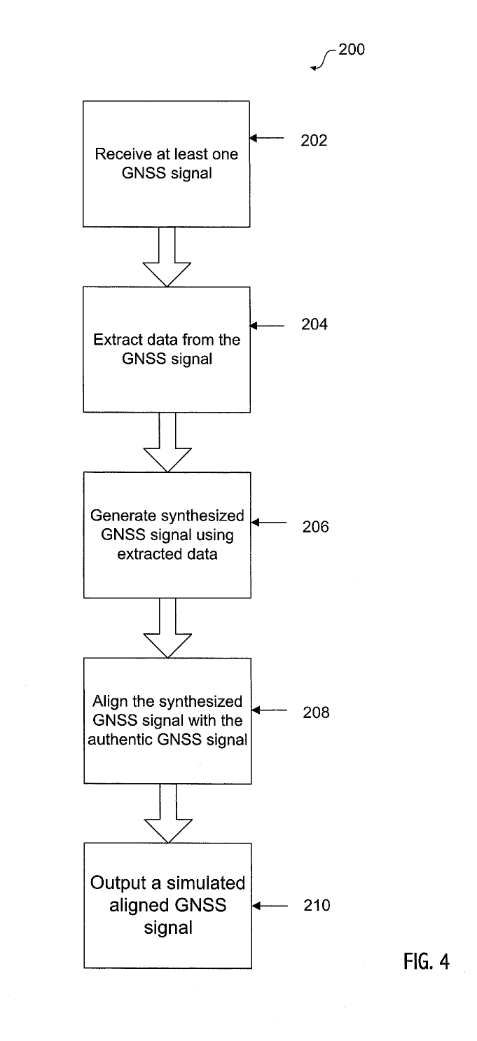

FIG. 4 is a flow chart of one method 200 for synthesizing phase-coherent GNSS signals. The method can be implemented partially or entirely on a digital signal processor. In other applications, implementation of the method can include hardware, computer readable medium, a special-purpose computer or a general-purpose computer. The various steps can occur in a different order or may occur simultaneously.

The method includes receiving, at a GNSS signal receiver, one or more ambient radio-frequency GNSS signals. (202) The method includes, receiving a plurality of radio-frequency GNSS signals. (202) Data and signal observables are extracted from the received GNSS signals. (204) Such observables can include: estimates {\hat{t}ₖ}₁ⁿ of the start times of the kth ranging code interval on receiver channels 1−n; estimates {\hat{θ}ₖ}₁ⁿ of the beat carrier phase on receiver channels 1−n at times {\hat{t}ₖ}₁ⁿ; estimates {\hat{f}_{D,k}}₁ⁿ of the carrier Doppler frequency shift on receiver channels 1−n at times {\hat{t}ₖ}₁ⁿ; estimated current time T; estimated position P and velocity V of the coupled receiver's antenna; and estimates of the signal amplitudes on receiver channels 1−n at times {\hat{t}ₖ}₁ⁿ.

The method further includes generating, with a GNSS signal simulator, one or more simulated radio-frequency GNSS signals. (206) A common timing reference is provided to both the GNSS signal receiver and the GNSS signal simulator. The method further includes aligning, via a control module, both a carrier phase and a code phase of the one or more simulated radio-frequency GNSS signals respectively with a carrier phase and a code phase of the one or more ambient radio-frequency GNSS signals at a predetermined three-dimensional position offset and a predetermined velocity offset relative to a reference location on the GNSS phase-coherent signal simulator. (208)

The synthesized signals can have carrier Doppler frequency shift offsets equal to {\hat{f}_{D,k}}₁ⁿ and code phases whose relative alignment is equivalent to that dictated by {\hat{t}ₖ}₁ⁿ. The method can further include compensation for buffering or other signal processing delays within the process. An accurate compensation can code-phase align and carrier phase align the simulated GNSS signal with the genuine ambient GNSS signal.

The simulator outputs the simulated GNSS signal that is code-phase and carrier-phase aligned with an ambient, authentic GNSS signal. (210).

A number of embodiments of the invention have been described. Nevertheless, it will be understood that various modifications may be made without departing from the spirit and scope of the invention. Accordingly, other embodiments are within the scope of the following claims.

What is claimed is:

1. A GNSS phase-coherent signal simulator comprising:
a GNSS signal receiver operable to receive one or more ambient radio-frequency GNSS signals;
a GNSS signal simulator operable to generate one or more simulated radio-frequency GNSS signals;
a timing oscillator coupled to both the GNSS signal receiver and the GNSS signal simulator; and
a control module operable to align both a carrier phase and a code phase of the one or more simulated GNSS signals respectively with a carrier phase and a code phase of the one or more ambient radio-frequency GNSS signals at a predetermined three-dimensional position offset and a predetermined velocity offset relative to a reference location on the GNSS phase-coherent signal simulator.

2. The GNSS phase-coherent signal simulator of claim 1, wherein at least one of the position offset and the velocity offset is substantially zero.

3. The GNSS phase-coherent signal simulator of claim 1, wherein the position offset and velocity offset are individually selectively variable.

4. The GNSS phase-coherent signal simulator of claim 1, wherein the position offset is less than about 10 km.

5. The GNSS phase-coherent signal simulator of claim 1, wherein the signal simulator is configured to compensate for at least one of a signal processing latency and an analog RF bias.

6. The GNSS phase-coherent signal simulator of claim 1, wherein the signal simulator is operable to align the simulated GNSS signal with the ambient GNSS signal within about one tenth of a carrier wavelength.

7. The GNSS phase-coherent signal simulator of claim 1, wherein the reference location comprises an input antenna location.

8. The GNSS phase-coherent signal simulator of claim 1, wherein position and velocity offset are selected to align the code and carrier phases along a trajectory.

9. A method of combining a plurality of GNSS signals, the method comprising:
receiving, at a GNSS signal receiver, one or more ambient radio-frequency GNSS signals;
generating, with a GNSS signal simulator, one or more simulated radio-frequency GNSS signals;
receiving, at both the GNSS signal receiver and the GNSS signal simulator, a common timing reference; and
aligning, via a control module, both a carrier phase and a code phase of the one or more simulated radio-frequency GNSS signals respectively with a carrier phase and a code phase of the one or more ambient radio-frequency GNSS signals at a predetermined three-dimensional position offset and a predetermined velocity offset relative to a reference location on the GNSS phase-coherent signal simulator.

10. The method of claim 9, wherein the aligning includes compensating for analog RF biases.

11. The method of claim 9, further comprising calibrating the GNSS signal simulator to account for signal processing latency.

12. The method of claim 9, wherein the velocity offset is selected for carrier phase and code phase alignment at a stationary point.

13. The method of claim 9, wherein the velocity offset is selected for continuous carrier phase and code phase alignment along a trajectory of a moving point.

14. The method of claim 9, wherein the simulated GNSS signal is aligned with the ambient GNSS signal within one tenth of a carrier wavelength.

15. The method of claim 9, further comprising estimating a Doppler frequency offset.

16. The method of claim 15, wherein the Doppler frequency offset is set to within about 1 Hz.

17. The method of claim 9, wherein the respective carrier and code phases are each aligned at a centimeter-level.

18. A method of phase aligning GNSS signals via a GNSS signal simulator, the method comprising:
receiving one or more ambient radio-frequency GNSS signals;
generating one or more simulated radio-frequency GNSS signals; and
aligning both a carrier phase and a code phase of the one or more simulated radio-frequency GNSS signals respectively with a carrier phase and a code phase of the one or more ambient radio-frequency GNSS signals at a predetermined three-dimensional position offset and a predetermined velocity offset relative to a reference location on the GNSS signal simulator.

19. The method of claim 18, further comprising providing a timing reference to a GNSS receiver and the GNSS simulator via an oscillator to facilitate phase alignment.
